(19) United States
(12) Patent Application Publication
(10) Pub. No.: US 2008/0020102 A1
(43) Pub. Date: Jan. 24, 2008

(54) Omega Fatty Acid Fortified Food Products And Methods For Preparing Same

(75) Inventors: Mukund V. Karwe, Monmouth Junction, NJ (US); Rafael Borneo, Cordoba (AR); Geetha Ghai, Murray Hill, NJ (US); Beverly Tepper, Rocky Hill, NJ (US); Dilek Kocer, Red Bank, NJ (US)

Correspondence Address: DANN, DORFMAN, HERRELL & SKILLMAN, 1601 MARKET STREET, SUITE 2400, PHILADELPHIA, PA, 19103-2307, US

(73) Assignee: RUTGERS, THE STATE UNIVERSITY OF NEW JERSEY, New Brunswick, NJ (US)

(21) Appl. No.: 11/571,951

(22) PCT Filed: Jul. 13, 2005
(86) PCT No.: PCT/US05/24795

§ 371 Date: Jul. 2, 2007

Related U.S. Application Data
(60) Provisional application No. 60/587,422, filed on Jul. 13, 2004.

(51) Int. Cl. A23L 1/30

(52) U.S. Cl. 426/106; 426/250; 426/274; 426/282; 426/648; 426/650; 426/654; 426/658; 426/659

(57) ABSTRACT

Omega-3 fatty acid (ω3FA) fortified food products and methods for preparing the same are provided.

This application claims priority under 35 U.S.C. §119(e) to U.S. Provisional Patent Application No. 60/587,422, filed on Jul. 13, 2004. The foregoing application is incorporated by reference herein.

### FIELD OF THE INVENTION

The present invention relates to omega-3 fatty acid (ω3FA) fortified food products and methods for preparing the same.

### BACKGROUND OF THE INVENTION

Interest in omega-3 fatty acids (ω3FA) as health promoting nutrients has expanded dramatically in the last several years (Shahidi and Finley (eds), Omega-3 Fatty Acids Chemistry, Nutrition, and Health Effects. (Washington, D.C., American Chemical Society, 2001). These ω3FA, particularly eicosapentaenoic acid (EPA, 20:5n-3) and docosahexaenoic acid (DHA, 22:6n-3), have been reported to have beneficial effects in many diseases. Indeed, EPA has been implicated in lowering cholesterol levels, cleaning blood vessels, preventing stroke, and preventing irregular heartbeats. Additionally, DHA has been shown to maintain and improve human memory and learning behavior.

Recommendations for optimal intake of total and unsaturated fatty acids have been proposed by a number of scientific authorities and organizations. A recent National Institute of Health (NIH) workshop on fatty acids concluded that there is sufficient evidence of the importance of ω3FA in the diet to recommend 220 mg of EPA/day and 220 mg of DHA/day as an adequate intake for adults. It has also been recommended that pregnant and lactating females take 300 mg/day of DHA. The workshop stated that “there are not enough data to determine the dietary reference intakes but there are good data to make recommendations for adequate intakes for adults” (Simopoulos et al. (2000) Prostaglandins Leukot. Essent. Fatty Acids, 63:119-121). Furthermore, it has been established that supplying ωFA in the diet through fortified foods will meet the body's metabolic needs better than a dietary supplement or pill (Maki et al. (2003) J. Food Sci., 86:761-764).

Notably, Canada recommends a total intake of 1.2-1.6 g/day of total ω3FA while not distinguishing between individual fatty acids (Kris-Etherton et al. (2000) Am. J. Clin. Nutr., 71:179-188). The UK Committee on Medical Aspects of Food and Nutrition policy recommends that the intake of EPA and DHA be 0.2 g/day or 1.5 g/week (British Nutrition Foundation, 1999). Australia has recommended that there be moderate increase in sources of ω3FA from plant foods (alpha-linolenic acid) and fish (EPA and DHA). Some of the recommendations are based on the ratio of ω6 to ω3 fatty acids. The World Health Organization has recommended a ratio of ω6 to ω3 fatty acids of 5-10:1 (Kris-Etherton et al. (2000) Am. J. Clin. Nutr., 71:179-188).

A number of food products containing ω3FA and some ω3FA-enriched food products have been marketed in recent years worldwide. These products include bread, eggs and egg products, pasta, pasta sauces, biscuits, cakes, fruit drinks, milk, milk shakes, dairy products, juices, soft drinks, meat, poultry, margarines and spreads, and ice cream. The major hurdle in the production of these fortified foods is the stability of the fatty acids during processing. The production of most of the bakery products, like bread, cookies, cakes and pasta products, involve processing at high temperatures. High temperatures and the presence of oxygen may lead to an undesirable increased oxidation of EPA and DHA. Additionally, most of the above-mentioned baked products have less than 50 mg of EPA and DHA per serving.

### SUMMARY OF THE INVENTION

In accordance with the instant invention a creamy product suitable as a filler or topping for edible goods and methods of preparing the same are provided. The creamy product comprises DHA and EPA at about 25 mg to about 500 mg each per serving unit, about 30% and about 70% by weight of at least one sweetening agent, at least one flavoring agent, about 7% to about 30% by weight of at least one shortening agent, and about 0.5% to about 10% by weight of at least one gelling agent. The creamy product may also further comprise at least one coloring agent, at least one preservative, and/or at least one supplemental agent.

In accordance with another aspect of the invention, food products and containers comprising the creamy product are provided. In a particular embodiment, the creamy product is presented as the filling of a sandwich cookie.

### BRIEF DESCRIPTIONS OF THE DRAWING

FIG. 1 is graphic representation of the gas chromatography analysis of the cream of the instant invention.

FIG. 2 is graphic representation of the gas chromatography analysis of ROPUFA®.

FIGS. 3A and 3B are graphic representations of the stability of EPA (FIG. 3A) and DHA (FIG. 3B) in cookies stored at 22° C. and 37° C. under atmospheric or vacuum sealed conditions.

### DETAILED DESCRIPTION OF THE INVENTION

In the United States, a recent NIH workshop has recommended the daily doses of fatty acids set forth in Table 1.

TABLE 1
Adequate intake (AI) of fatty acids for adults
(Simopoulos et al. (2000) Prostaglandins
Leukot. Essent. Fatty Acids, 63: 119-121)

| | Grams/day | |
|---|---|---|
| Fatty acid | (2000 kcal diet) | % Energy |
| Linoleic acid (LA) | 4.44 | 2.0 |
| (Upper Limit) | 6.67 | 3.0 |
| Linolenic acid (LNA) | 2.22 | 1.0 |
| DHA + EPA | 0.65 | 0.3 |
| DHA to be at least | 0.22 | 0.1 |
| EPA to be at least | 0.22 | 0.1 |
| Trans fatty acids | | |
| (Upper Limit) | 2.0 | 1.0 |
| Saturated fatty acids | | |
| (Upper Limit) | — | <8.0 |
| Monounsaturated fatty acids | — | — |

The instant invention provides an edible cream comprising a mixture of EPA and DHA stably encapsulated in a matrix of starch and gelatin. The creamy product of the instant invention is suitable as a filler or topping for edible goods.

In one embodiment, the cream of the instant invention can be packaged in sealed containers of either rigid or flexible construction. For example, the cream can be in a flexible plastic tube to allow for squeezing the sweet, creamy product onto or into a cooked or raw food product, for eating as is or after cooking.

In yet another embodiment, the cream can be used to prepare filled and/or topped edible products. Broadly speaking, the cream can be employed in edible products including bakery, dessert, snack, candy, dairy, nut, meat, egg, and vegetable products. In particular, the edible products are baked goods, such as cakes, base cakes, cookies, pies, tarts, breads, rolls, crackers, pastries, pretzels, biscuits, wafers, eclairs, and crisps.

In another particular embodiment, the cream can be placed between two or more food products such as cookies, base cakes, crackers (e.g., graham cracker and low fat honey graham crackers (Nabisco)), wafers, nilla wafers, biscuits, or crisps to create a sandwich. In a particular embodiment, the food product is softer and/or more breakable than average so as to prevent a soft filler cream from being squeezed out of the sides of a sandwich. Sandwiches of the invention typically comprise food products (e.g., top and bottom cookie) which are identical, however, the sandwiches may comprise food products which are different (e.g., dissimilar in shape and/or color, one or more may have a hole or holes through which the cream can be seen). The sandwiches may have multiple layers of cream between the food products and may have multiple layers of food products (e.g., food product-cream-food product-cream-food product). The food products may be enrobed with a chocolate or other coating and/or contain salt.

The creamy product of the instant invention comprises at least one source of DHA and EPA, at least one sweetening agent, at least one flavoring agent, at least one shortening agent, at least one gelling agent, optionally at least one coloring agent, optionally at least one preservative, and optionally at least one supplemental agent. Optionally, the cream may comprise any other edible, non-toxic compound.

Flavoring agents may include any non-toxic, natural or artificial flavoring agent known in the art. In particular, flavoring agents include, without limitation, sodium chloride, fruit flavors (e.g., orange, lemon, lime, blueberry, raspberry, pear, kiwi, cherry, apple, berry, citrus, apricot, mango, peach, grapefruit, tangerine, pineapple, banana, grape, passion fruit, strawberry, watermelon, and kiwi), vanilla, chocolate, cocoa, peanut butter, cola, root beer, coffee, cream soda, pistachio, hazelnut, almond, honey, mint flavors (e.g., peppermint and spearmint), spices (e.g., ginger, cinnamon, clove, and nutmeg), marshmallow, butterscotch, and caramel. In a particular embodiment, the flavoring agent is orange. Flavor enhancers may be used in combination with the flavoring agents. The cream of the instant invention comprises, by weight, about 0.1% to about 10% of flavoring agent, preferably about 0.3% to about 5% of flavoring agent.

Coloring agents may include any natural or artificial food coloring that is non-toxic and known in the art. In particular, coloring agents, include, without limitation, Red No. 2, Red No. 3, Red No. 4, Red No. 22, Red No. 28, Red No. 40, Yellow No. 1, Yellow No. 5, Yellow No. 6, Yellow No. 10, Green No. 3, Green No. 5, Green No. 6, Blue No. 1, Blue No. 2, annatto, anthocyanins, beet extracts, beta-carotene, caramel, carmine/cochineal, paprika oleoresin, and turmeric. The cream of the instant invention comprises, by weight, about 0.01% to about 2% of coloring agent.

Sweetening agents may include any non-toxic, natural or synthetic sweetener known in the art. In particular, sweetening agents include, without limitation, sucrose, glucose, fructose, dextrose, maltose, maltodextrins, L-alanine, glycine, sorbitol, mannitol, xylitol, saccharin, saccharinate, licorice extracts, cyclamate salts, sucralose, L-aspartyl-L-phenylalanine methyl ester (aspartame), ammonium cyclamate, sugar, powdered sugar, monosaccharides, disaccharides, polysaccharides, fructose, dextrose, corn syrups, high fructose corn syrup, fructose syrup, molasses, and maltodextrin. In a particular embodiment, the sweetening agent is 10× powdered sugar. The cream of the instant invention comprises, by weight, about 30% to about 70% of sweetening agent, preferably about 40% to 60% of sweetening agent, more preferably about 50% of sweetening agent.

Gelling agents are well-known to those skilled in the art and include natural or synthetic agents. Examplary gelling agents include, without limitation, cellulosics, gums, cellulose, methylcellulose, hydroxypropylcellulose, starch, chitin, carrageenan, konjac, guar gum, xanthan gum, alginic acid and derivatives thereof, agar, pectin, and gelatin. In a particular embodiment, the gelling agent is gelatin. The cream of the instant invention comprises, by weight, about 0.5% to about 10% of gelling agent, preferably about 1% to about 5% of gelling agent.

Shortening agents are well-known to those skilled in the art and include natural or synthetic shortenings; solid, plastic, liquid, or semifluid shortenings; shortenings derived from animals, and vegetable fats and oils. Shortening agents may comprise saturated or unsaturated “long-chain” acyl radicals. Shortening agents include those obtained from edible oils and fats such as corn oil, cottonseed oils, soybean oil, coconut oil, rapeseed oil, peanut oil, olive oil, palm oil, palm kernel oil, canola oil, sunflower seed oil, safflower oil, lard, and tallow oil. In a preferred embodiment, the shortening agent is Crisco® shortening or oil (Procter & Gamble Company; Cincinnati, Ohio), which is soybean-based base. Low fat shortenings may also be used. The cream of the instant invention comprises, by weight, about 7% to about 30% of shortening agent, preferably about 15% to about 20% of shortening agent.

Preservatives are well-known to those skilled in the art and are generally agents which inhibit the growth of mold, yeasts, and/or bacteria on or in an edible product. Preservatives include, without limitation, sodium chloride, benzoates (e.g., sodium benzoate, calcium benzoate, and potassium benzoate), nitrites (such as sodium nitrite), sulphites (such as sulphur dioxide), sorbates (e.g., sodium sorbate, potassium sorbate, and calcium sorbate), nisin, and sorbic acid. These agents can be included in amounts readily determinable by the skilled artisan.

Supplemental agents include, without limitation, caffeine, dietary supplements, natural herbs, vitamins (e.g., pyridoxine hydrochloride, vitamin A, vitamin E, niacin, thiamin, folic acid, vitamin B1, vitamin B2, vitamin B6, vitamin B12, vitamin C, vitamin E and calcium pantothenate), antioxidants (e.g., butylated hydroxyanisole (BHA) and butylated hydroxytoluene (BHT)), mineral, and amino acids. These agents can be included in amounts readily determinable by the skilled artisan.

The cream of the present invention can also contain other ingredients depending upon the flavor or other properties desired. For example, the instant cream may further comprise, without limitation, milks, milk powders, milk solids, eggs, cornstarch, potato, rice, fruits, nuts, vegetables, cheeses, meats, lecithins, emulsifiers, and bulking agents (e.g., polydextrose, isomalt, isomaltulose, polyglucose, polymaltose, carboxymethyl-cellulose, microcrystalline cellulose, cellulose gel, and arabinogalactan). These agents can be included in amounts readily determinable by the skilled artisan.

Additionally, it is known that higher moisture retention in products can enhance the retention of some health promoting nutraceutical compounds (Walker, C. E., AIB Research Department Technical Bulletin, Vol. XI (11), November 1987).

Preliminary sensory evaluation of the cream of the instant invention showed no appreciable off-odors or aftertaste. Additionally, the DHA and EPA of the cream are stable (see Example).

The source of DHA and EPA can be natural or synthetic. For example, DHA and EPA may be obtained from fish oil or algae or obtained from numerous manufacturers (e.g., Martek, Columbia, Md.; DSM Inc., Heerlen, Netherlands). In a particular embodiment, the source of DHA and EPA is ROPUFA®. In another particular embodiment, the creams of the instant invention preferably comprise DHA and EPA in quantities sufficient to satisfy and/or exceed the daily recommended intake of DHA and EPA without reaching determined toxicity levels (optionally considering other dietary and supplemental sources of DHA and EPA) in about 1 to about 10 serving units, more preferably in about 1 to about 5 serving units. In yet another particular embodiment, the cream of the instant invention comprises about 25 mg to about 500 mg each of DHA and EPA (50 to 1000 mg total) per serving unit (e.g., sandwich cookie), preferably about 100 to about 300 mg each of DHA and EPA per serving unit, more preferably about 200 to about 225 mg each of DHA and EPA per serving unit. Preferably, the source of DHA and EPA is ROPUFA® n-3 Food Powder (DSM Inc., formerly Roche Vitamins Inc.). According to the manufacturer, ROPUFA® n-3 is intended for the manufacture of foodstuffs and pharmaceuticals and for the manufacture of baby food. ROPUFA® is a mixture of poly-unsaturated fatty acids of animal origin (fish oil), stabilized with tocopherols, ascorbylpalmitate, rosemary extract, and sodium ascorbate, finely dispersed in a matrix of fish gelatin, sucrose, and starch. Specifically, sucrose comprises 20-25%, starch comprises 20-25%, sodium ascorbate crystalline is a maximum of 5%, n-3 poly-unsaturated fatty acids is a minimum of 9%, and n-3 long chain poly-unsaturated fatty acids is a minimum of 7%.

Also, according to the manufacturer, the acute toxicity of n-3 fish oil/major component of ROPUFA® is an LD50 of >2000 mg/kg (oral, rat). Accordingly, the FDA has recommended not exceeding 2 g/day of trans fatty acids. Additionally, it is not mutagenic according to the Ames test and is a non-irritant (rabbit) of the skin and eye. Minor components such as tocopherols, ascorbylpalmitate, rosemary extract, and sodium ascorbate as well as fish gelatin and sucrose are considered as GRAS (generally recognized as safe). Inasmuch as the amount of omega 3 fatty acids (DHA and EPA) per cookie is 400 mg, up to 5 cookies can safely be consumed daily within the limits recommended by the FDA.

An exemplary formulation of the instant cream is:

| | |
|---|---|
| Sugar 10X (Domino Inc.) | about 40-45% |
| Super Envision (Domino Inc.) | about 0.4-0.5% |
| ROPUFA (DSM Inc.) | about 25-27% |
| Vegetable Shortening (Crisco ®) | about 17-19% |
| Citric Acid (DSM Inc.) | about 0.2-0.3% |
| Salt (Morton) | about 0.2-0.25% |
| Corn Syrup (ADM) | about 5-7% |
| Gelatin solution (5 g/55 ml) | about 3-4% |
| Color (Yellow #5) | about 0.03% |
| Lemon flavor (Virginia Dare) | about 0.1-0.5% |
| Flavor enhancer (Virginia Dare) | about 0.1-0.5% |

A specific exemplary formulation of the cream of the instant invention is provided in Table 2.

TABLE 2
Exemplary formulation of cream.

| Ingredient | Percent |
|---|---|
| Sugar 10X (Domino Inc.) | 43.06% |
| Super Envision (Domino Inc.) | 0.43% |
| ROPUFA ® (DSM Inc.) | 25.83% |
| Vegetable Shortening (Crisco ®) | 17.94% |
| Citric Acid (DSM Inc.) | 0.27% |
| Salt (Morton) | 0.22% |
| Corn Syrup (ADM) | 6.09% |
| Gelatin solution (5 g/55 ml) | 3.44% |
| Color (Yellow #5) | 0.03% |
| Lemon extract (McCormick) | 2.69% |
| | 100.00% |

Another specific exemplary formulation of the cream of the instant invention is provided in Table 3, along with a placebo.

TABLE 3
Exemplary formulation of cream.

| | |
|---|---|
| ROPUFA | PLACEBO |

| | Grams | % | Grams | % |
|---|---|---|---|---|
| Sugar 10X | 240.00 | 44.03 | 240.00 | 44.03 |
| Super Envision | 2.40 | 0.44 | 2.40 | 0.44 |
| ROPUFA | 144.00 | 26.42 | 0 | 0 |
| Corn starch/gelatin (1:1) | 0 | 0 | 144.00 | 26.42 |
| Shortening (vegetable) | 100.00 | 18.35 | 100 | 18.35 |
| Citric Acid | 1.50 | 0.29 | 1.50 | 0.29 |
| Salt | 1.20 | 0.22 | 1.20 | 0.22 |
| Corn Syrup | 33.95 | 6.23 | 33.95 | 6.23 |
| Gelatin Sol. (5 g/55 ml) | 19.20 | 3.52 | 19.20 | 3.52 |
| Yellow color | 7 drops | | 7 drops | |
| Lemon flavor | 1.8 | 0.33 | 1.8 | 0.33 |
| Flavor enhancer | 1.0 | 0.18 | 1.0 | 0.18 |

An exemplary nutrition label for the cookies comprising the cream of the instant invention is provided in Table 4.

TABLE 4
Exemplary nutritional label.
Nutrition Facts

| Serving size | 1 cookie |
|---|---|
| Serving per container | 1 |

Amount per serving

| Calories | 120 |
|---|---|
| Total fat, g | 13 |
| EPA, mg | 200 |
| DHA, mg | 215 |
| Total carbohydrates, g | 17 |
| Sugars, g | 14 |
| Protein, g | 9 |
| Ingredients: sugar, enriched flour (wheat flour, niacin, reduced iron, thiamine monohidrate[vitamin B1}, riboflavin [vitamin B2], folic acid), graham flour, honey, partially hidrogenated soybean oil, high fructose corn syrup, calcium carbonate (souce of calcium), leavening | |
| # (baking soda, calcium phosphate), salt, citric acid, emulsifiers (monoglycerides), soy lecithin, vainillin, artificial flavor, lemon extract, yellow #2 (for color), encapsulated (starch and gelatin) fish oil (source of EPA and DHA) | |

The method of producing the cream of the instant invention is exemplified in the Example. The method of production is exemplified hereinbelow on a small scale. However, commercial scale production of the creamy product is encompassed within the instant invention. As high temperatures are not used during processing, there is no possibility of generating heat-induced degradation products. All processing can be done at room temperature and involve simple mixing.

The following example describes illustrative methods of practicing the instant invention and is not intended to limit the scope of the invention in any way.

### EXAMPLE

A preparation of the cream of the instant invention can be prepared by the following method.

1) Weigh gelatin (10 g), add to cold water (110 g), heat to 65° C. with mixing to allow the gelatin to dissolve. Keep at 55° C. until use.

2) Weigh dry ingredients separately (sugar, super envision, salt, citric acid, ROPUFA®). Keep them in separate containers until use.

3) Weigh liquid ingredients (corn syrup, lemon extract, color) and mix them gently.

4) Using a Hobart mixer on low speed, mix dry ingredients, starting with sugar and adding sequentially, super envision, salt, and citric acid.

5) Add shortening and mix at low speed until fat is dispersed in dry solids (small particle size).

6) Add liquid ingredients, mix, and add gelatin solution at the end of mixing.

7) Add ROPUFA® at the end, mix a few seconds (15 max) with Hobart, then incorporate all ROPUFA® by hand into mix with a help of spatula.

A cookie sandwich comprising the cream of the instant invention may be assembled by the following method.

1) Take two cookies (top and bottom).

2) Weigh 25 g of cream comprising 400 mg of DHA and EPA/20 g of cream.

3) Deposit cream in center of top of one of the cookies.

4) With the other cookie press down so as to spread cream.

5) Place cookie in packaging pouch and seal.

The moisture content of the samples was measured using the Sartorius MA 30 Moisture Analyzer. A powdered sample (mortar and pestle) of approximately 10 g was placed in the analyzer plate. The temperature was set at 95° C. When the moisture loss per unit of time reaches zero, the percentage of moisture is displayed. The moisture content of the samples ranged between 6.75%-7.25% (wet basis).

The fatty acid composition of the cookies was also determined using the A.O.C.S. Official method Ce1b-89 for marine oils and marine oil esters that involves saponification. C25:0 methyl ester was used as an internal standard (IS). The procedure used was as follows:

1) 100 mg of 25:0 methyl ester was weighed into a 100 ml volumetric flask and made to volume with hexane to provide an IS solution.

2) 1 ml of IS solution in hexane was pipetted into culture tube and the solvent was evaporated.

3) Approximately 25-30 mg of powdered sample was weighed into the culture tube containing the IS.

4) 1.5 ml of 0.5N NaOH (reagent grade) was added to the lipid sample and heated for 5 min at 100° C.

5) After saponification, 2 ml of BF₃ (12% in methanol (reagent grade)) reagent was added and heated for 1 hour at 100° C. with thorough mixing.

6) The mixture was cooled to room temperature, 1 ml of hexane (reagent grade) was added, and the mixture was vortexed. 5 ml of NaCl solution (saturated solution, dissolve 36 g NaCl in 100 mL distilled water) was added immediately and agitated thoroughly.

7) After cooling to room temperature, the hexane layer was separated from the aqueous layer and transferred into a clean glass tube and capped.

8) The methanol/water phase was extracted twice with additional hexane and the hexane extracts were combined and then concentrated to 1 ml under a stream of dry nitrogen.

9) The concentrated extract was injected into a gas chromatograph (GC).

The chromatography conditions employed were:

Agilent 6850 series gas chromatograph;

Flame ionization detector, integrator and auto sampler;
Column: A fused silica column 30 m×0.25 mm ID×0.20 μm film thickness (SP-2330; Supelco, Bellefonte, Pa.);
Carrier gas: He, 24 ml/min;
Injection port temperature: 250° C.;
Detector temperature: 300° C.;
Split ratio: 50:1;
Hydrogen gas flow rate: 30 ml/min;
Air flow: 300 ml/min;
Temperature program: The column oven temperature was programmed for an initial temperature of 50° C. at a rate of 40° C./min until a temperature of 170° C. was reached for the first stage. In the second stage, the temperature was increased at a rate of 2° C./min until a temperature of 200° C. was reached. In the third stage, the temperature was held at 200° C. for 10 min, and then increased at a rate of 40° C./min until a final temperature of 240° C. was reached. It was held at 240° C. for 1 min. The total run time was 45 min. The autosampler was programmed to rinse the syringe twice with solvent (hexane) and then with the sample before injecting the sample with a split ratio of 50:1.

Due to the limited sample capacity of capillary columns, it is very common to “split” the amount of sample entering the column, particularly when concentrated samples are used. During a split injection, the sample is introduced into a heated injection port where it is volatilized. The sample vapor moves swiftly though the injection port liner by a large carrier gas flow rate. As it exits the liner, a small portion of sample enters the capillary column, but the majority diverts out the split vent. The ratio of sample out the split vent versus sample on the column is called the split ratio.

The standards used for analysis—omega-3 fatty acids and other fatty acids were obtained from Sigma Chemical Company (St. Louis, Mo.). The standards of methyl esters of fatty acids C14:0 to C22:6 were chromatographed in the GC and the average retention times of three replicates were obtained. The retention time of ω3 fatty acid standards—linolenic acid, EPA and DHA were also noted by injecting pure methyl ester samples. Identification of fatty acid methyl esters in the samples was accomplished by employing the coincidence of retention indices.

The retention peaks of the samples were compared with standards whose peaks have identical retention times. The contents of EPA (C20:5 ω3) and DHA (C22:6 ω3) were quantified using an internal standard. The total area counts integrated were used to compare the quantity of the ω3 fatty acids present to that of the internal standard. Three replicates of injection were performed for each isolate to determine the mean and the standard deviation.

Formula:
EPA or DHA mg/g=[(A_{S})(W_{IS})]/[(A_{IS})(W_{S})]*1000
Where A_{S}—Area count of EPA or DHA
W_{IS}—Weight of internal standard added to the sample (mg)
A_{IS}—Area count of internal standard
W_{S}—Weight of the sample in mg

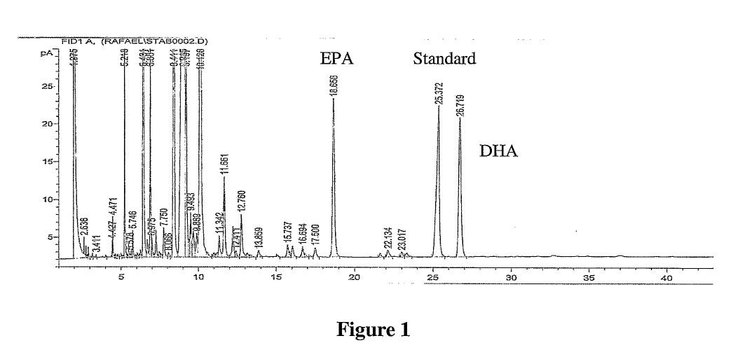

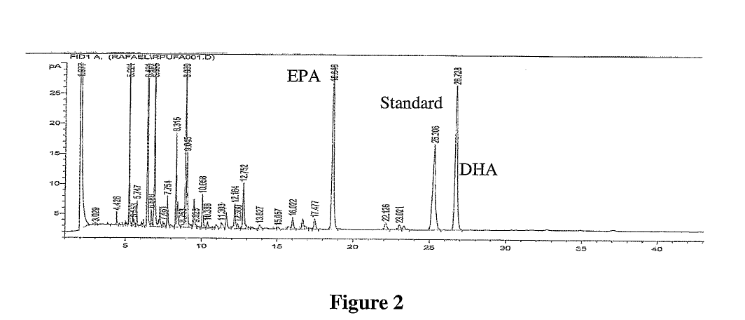

The product was subjected to fatty acid determination and quantification. An official method was used (AOAC, 1991). The fatty acid profile of methyl esters obtained from the cream product is shown in FIG. 1. For comparison, the fatty acid composition of ROPUFA is shown in FIG. 2. There are no differences between the fatty acid profiles in the area of long chain fatty acids, i.e. peaks having retention times above 18 minutes, including those corresponding to EPA and DHA.

Some differences are observed in the region of medium chain fatty acids, which have retention times below 18 minutes. The presence of shortening in the cream formulation is responsible for the additional peaks observed in this region.

One of the main products of oil oxidation was also tested for. The concentration of dienes present in the cream was tested according to the method used by Frankel et al. (1994) J. Agric. Food Chem. 42:1054-59). The amounts obtained were low (less than 25 mmoles/kg) as compared to those of salmon oil, which showed appreciable signs of oxidation (400-600 mmoles/kg).

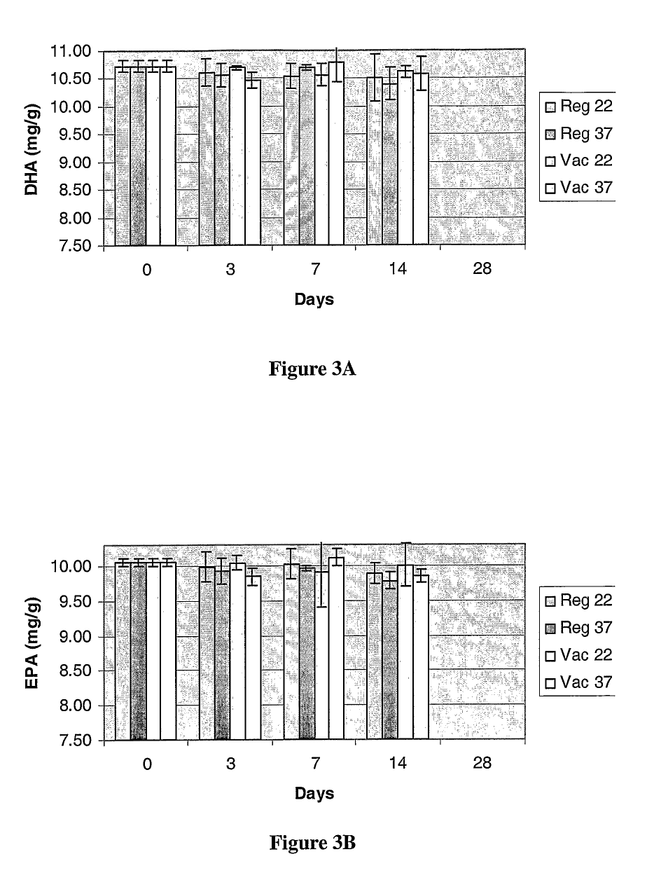

Cookie sandwiches comprising the cream of the instant invention have been stored at two different temperatures (22° C. and 37° C.) and under two different packaging conditions (atmospheric and vacuum packed) for 30 days (see FIGS. 3A and 3B). At regular intervals, cookies were analyzed for moisture, water activity, EPA/DHA, and dienes concentration. EPA and DHA were quantified by the AOAC official method using an internal standard. The results demonstrate that there were no significant differences between the amounts of EPA/DHA lost during storage under the various conditions of the study. A maximum loss of 5% was observed after 30 days of storage. The concentrations of dienes obtained under different conditions were low (less than 25 mmoles/kg) as compared to salmon oil, which evinced appreciable signs of oxidation (400-600 mmoles/kg).

A number of publications and patent documents are cited throughout the foregoing specification in order to describe the state of the art to which this invention pertains. The entire disclosure of each of these citations is incorporated by reference herein.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A creamy product suitable as a filler or topping for edible goods, said creamy product comprising:
a) DHA and EPA at about 25 mg to about 500 mg each per serving unit,
b) about 30% and about 70% by weight of at least one sweetening agent,
c) at least one flavoring agent,
d) about 7% to about 30% by weight of at least one shortening agent, and
e) about 0.5% to about 10% by weight of at least one gelling agent.

2. The creamy product of claim 1 further comprising at least one selected from the group consisting of:
a) at least one coloring agent,
b) at least one preservative, and
c) at least one supplemental agent.

3. The creamy product of claim 1 comprising DHA and EPA at about 200 to about 225 mg each per serving unit.

4. The creamy product of claim 1 wherein said DHA and EPA are provided by ROPUFA®.

5. The creamy product of claim 1 comprising:
a) about 40-45% of sugar 10×;
b) about 0.4-0.5% of Super Envision;
c) about 25-27% of ROPUFA®;
d) about 17-19% of Crisco®;
e) about 0.2-0.3% of citric acid;
f) about 0.2-0.25% of salt;
g) about 5-7% of corn syrup;
h) about 3-4% of gelatin solution (5 g/55 ml);
i) about 0.03% of Yellow #5;
j) about 0.1-0.5% of lemon flavor; and
k) about 0.1-0.5% of flavor enhancer.

6. A food product filled or topped with the creamy product of claim 1.

7. The food product of claim 6, wherein said food product is a sandwich cookie.

8. The food product of claim 7, wherein said sandwich cookie comprises said creamy product between two graham crackers.

9. A tube comprising the creamy product of claim 1.
